(19) United States
(12) Patent Application Publication
(10) Pub. No.: US 2016/0291676 A1
(43) Pub. Date: Oct. 6, 2016

(54) INFORMATION PROCESSING DEVICE, POWER CONTROL METHOD, PROGRAM, AND CONTROL DEVICE

(71) Applicant: NEC Corporation, Tokyo (JP)

(72) Inventor: SHUNSUKE AKIMOTO, Tokyo (JP)

(73) Assignee: NEC Corporation

(21) Appl. No.: 15/079,281

(22) Filed: Mar. 24, 2016

(30) Foreign Application Priority Data
Mar. 30, 2015 (JP) 2015-068825

(51) Int. Cl. G06F 1/32

(52) U.S. Cl. CPC G06F 1/3234

(57) ABSTRACT

An information processing device has: a plurality of components supplied with power and performing given operations; a power allocation control part controlling the ratio of power allocated to the plurality of components; and an operation status acquisition part acquiring the operation status of at least one of the plurality of components. The power allocation control part controls the ratio of power allocated to the plurality of components so that a preset condition is satisfied on the basis of the operation status of at least one of the plurality of components.

### INCORPORATION BY REFERENCE

This application is based upon and claims the benefit of priority from Japanese patent application No. 2015-068825, filed on Mar. 30, 2015, the disclosure of which is incorporated herein in its entirety by reference.

### TECHNICAL FIELD

The present invention relates to an information processing device, a power control method, a program, and a control device.

### BACKGROUND ART

There is a case where an information processing device such as a computer operates with limited power consumption. Then, in the case of operating with limited power consumption, the information processing device may allocate power to a plurality of components included thereby within a previously allowed upper limit range.

One of the techniques for realizing such power distribution is disclosed in Patent Document 1, for example. Patent Document 1 discloses a system. The system includes a plurality of components such as a processor, a memory and an input/output device, and associates each of the components with its own power monitor. According to Patent Document 1, the configuration makes it possible to monitor power consumption of the respective components. As a result, according to Patent Document 1, it is possible to execute predetermined control such as giving a warning depending on power consumption of each of the components. Moreover, for example, it is possible to analyze power consumption of the component monitored by its own power monitor and execute control appropriate for the analysis result.

Further, for example, Patent Document 2 discloses a technique of dynamically controlling power allocations depending on the characteristic of a device and the preference of a user. According to Patent Document 2, power is preferentially allocated to a function which the user prefers, for example. Moreover, according to Patent Document 2, a pause parameter or the like is controlled in response to decrease of available power, for example.

Patent Document 1: Japanese Unexamined Patent Application Publication No. JP-A 2007-042090
Patent Document 2: Japanese Unexamined Patent Application Publication No. JP-A 2005-518043

However, either the technique disclosed in Patent Document 1 or the technique disclosed in Patent Document 2 does not consider a workload characteristic in execution of processing by a target component. Therefore, power distribution using the techniques disclosed in Patent Documents 1 and 2 may lower workload performance.

For example, the following case will be assumed; in a processor package configured by multiple chips, the upper limit of total power supplied to a CPU die and a memory die is fixed. In this case, workload performance may decrease when workload characteristics (a processor usage rate and the like) on the processor do not fit the power balance between the CPU and the memory.

Thus, there is a problem that workload performance may decrease depending on the ratio of power allocated to the respective components.

### SUMMARY OF THE INVENTION

Accordingly, an object of the present invention is to provide an information processing device which solves the problem that workload performance may decrease depending on the ratio of power allocated to the respective components.

In order to achieve the object, an information processing device as an aspect of the present invention has a plurality of components which are supplied with power and perform given operations, and the information processing device includes a microprocessor including:

a plurality of components supplied with power and performing given operations;

a power allocation control part controlling a ratio of power allocated to the plurality of components; and

an operation status acquisition part acquiring an operation status of at least one of the plurality of components.

The power allocation control part controls a ratio of power allocated to the plurality of components so that a preset condition is satisfied on a basis of an operation status of at least one of the plurality of components.

Further, a power control method as another aspect of the present invention has:

acquiring an operation status of at least one of a plurality of components; and

controlling a ratio of power allocated to the plurality of components so that a preset condition is satisfied on a basis of the acquired operation status of at least one of the plurality of components.

Further, a program as another aspect of the present invention is a program having instructions for causing an information processing device which has a plurality of components supplied with power and performing given operations to realize:

a power allocation control unit controlling a ratio of power allocated to the plurality of components; and

an operation status acquisition unit acquiring an operation status of at least one of the plurality of components.

The power allocation control part controls a ratio of power allocated to the plurality of components so that a preset condition is satisfied on a basis of an operation status of at least one of the plurality of components.

Further, a control device as another aspect of the present invention has a microprocessor including:

a power allocation control part controlling a ratio of power allocated to a plurality of components supplied with power and performing given operations; and

an operation status acquisition part acquiring an operation status of at least one of the plurality of components.

The power allocation control part controls a ratio of power allocated to the plurality of components so that a preset condition is satisfied on a basis of an operation status of at least one of the plurality of components.

With the configurations as described above, the present invention can provide an information processing device which solves the problem that workload performance may decrease depending on the ratio of power allocated to the respective components.

### BRIEF DESCRIPTION OF DRAWINGS

FIG. 1 is a block diagram showing an example of the configuration of a computer according to a first exemplary embodiment of the present invention;

FIG. 2 is a block diagram showing an example of the configuration of a CPU chip according to the first exemplary embodiment of the present invention;

FIG. 3 is a block diagram showing an example of the configuration of a node performance controller according to the first exemplary embodiment of the present invention;

FIG. 4 is a diagram showing an example of control by the node performance controller according to the first exemplary embodiment of the present invention;

FIG. 5 is a diagram for describing a processor-first power allocation policy set by a power allocation policy setting unit according to the first exemplary embodiment of the present invention;

FIG. 6 is a diagram for describing the hill climbing method;

FIG. 7 is a diagram for describing a memory-first power allocation policy set by the power allocation policy setting unit according to the first exemplary embodiment of the present invention;

FIG. 8 is a diagram for describing a balanced power allocation policy set by the power allocation policy setting unit according to the first exemplary embodiment of the present invention;

FIG. 9 is a flowchart showing an example of the operation of the node performance controller in a case where the processor-first power allocation policy is set;

FIG. 10 is a flowchart showing an example of the operation of the node performance controller in a case where the memory-first power allocation policy is set;

FIG. 11 is a flowchart showing an example of the operation of the node performance controller in a case where the balanced power allocation policy is set;

FIG. 12 is a diagram showing an example in displaying a power allocation policy and the ratio of power to be allocated;

FIG. 13 is a diagram showing an example of control by the node performance controller according to a second exemplary embodiment of the present invention;

FIG. 14 is a flowchart showing an example of the operation of the node performance controller according to a second exemplary embodiment of the present invention;

FIG. 15 is a schematic block diagram showing an example of the configuration of an information processing device according to a third exemplary embodiment of the present invention; and

FIG. 16 is a schematic block diagram showing an example of the configuration of a control device according to a fourth exemplary embodiment of the present invention.

### EXEMPLARY EMBODIMENT

### First Exemplary Embodiment

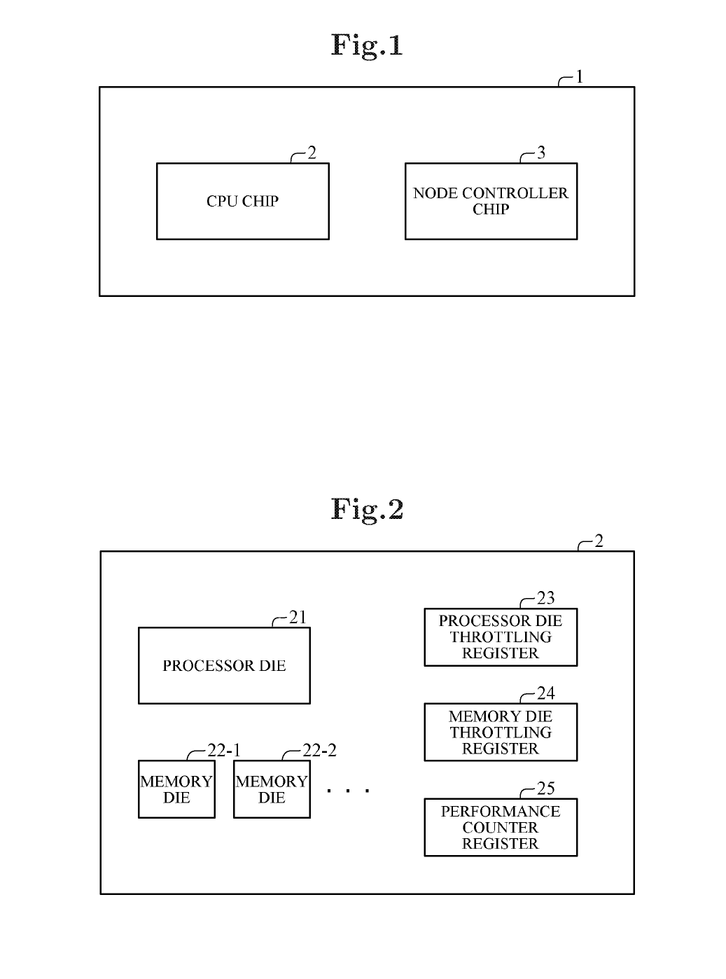

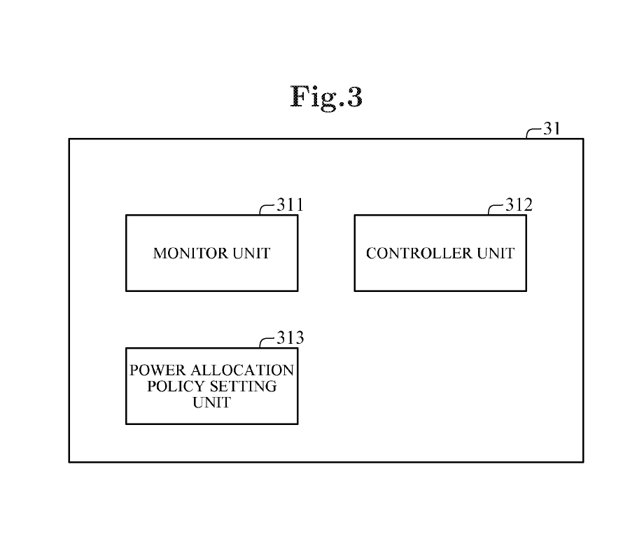

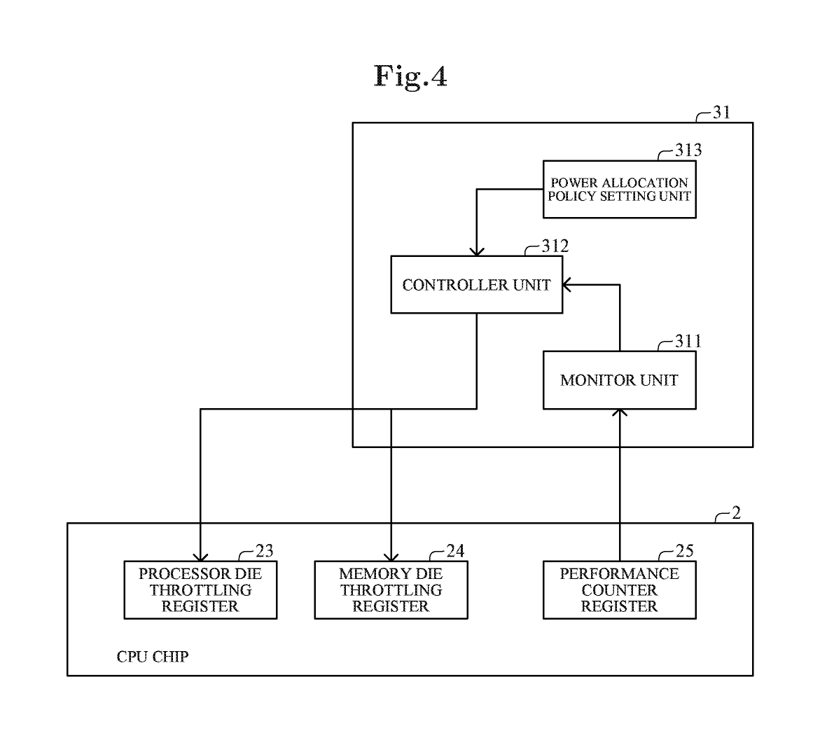

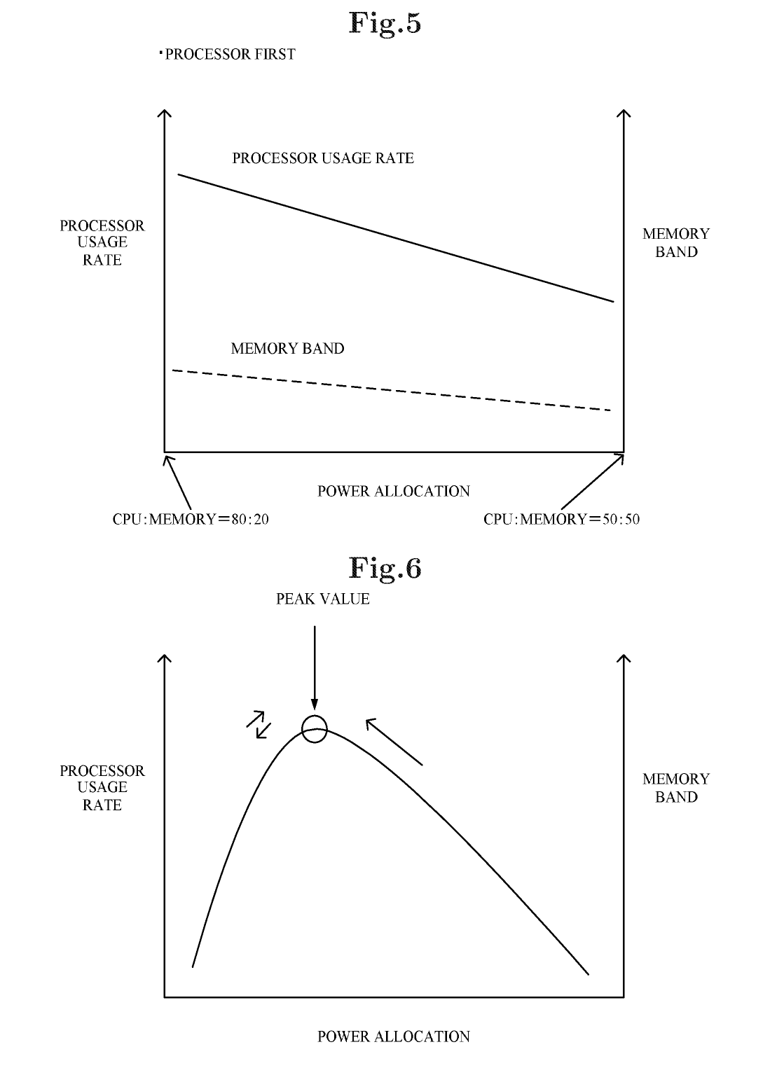

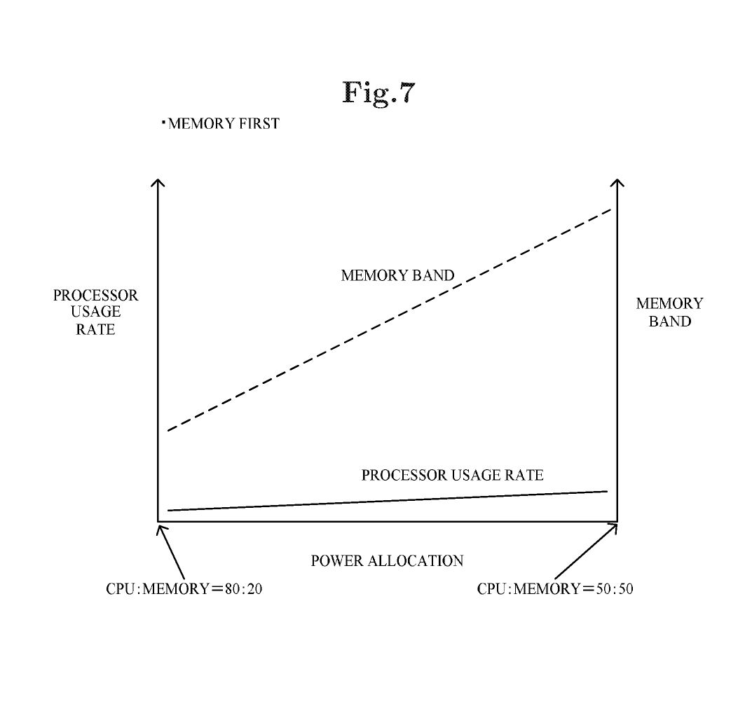

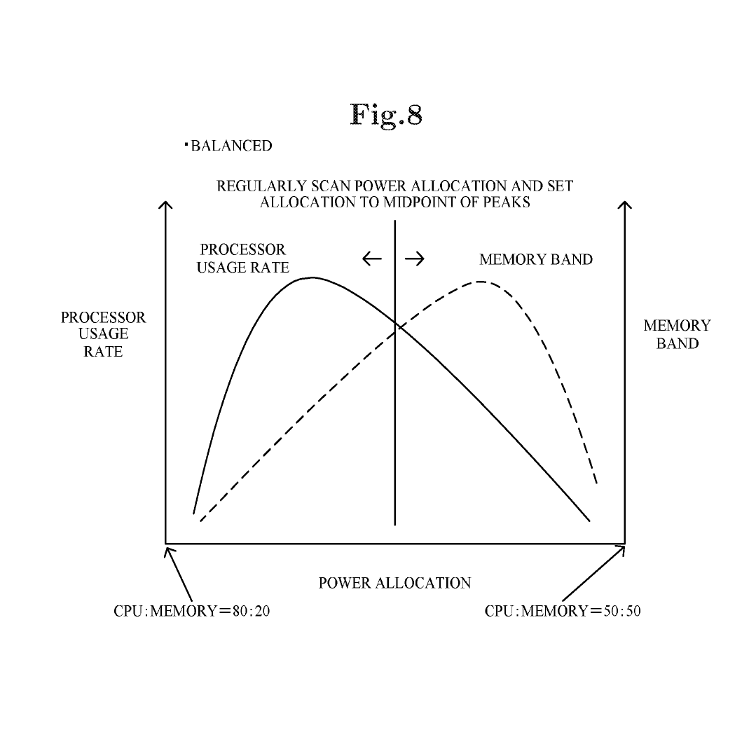

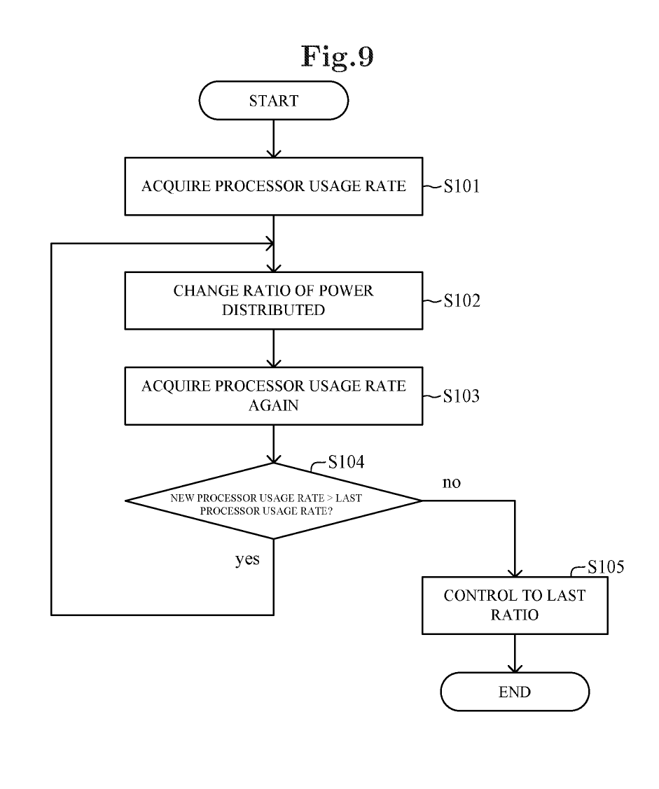

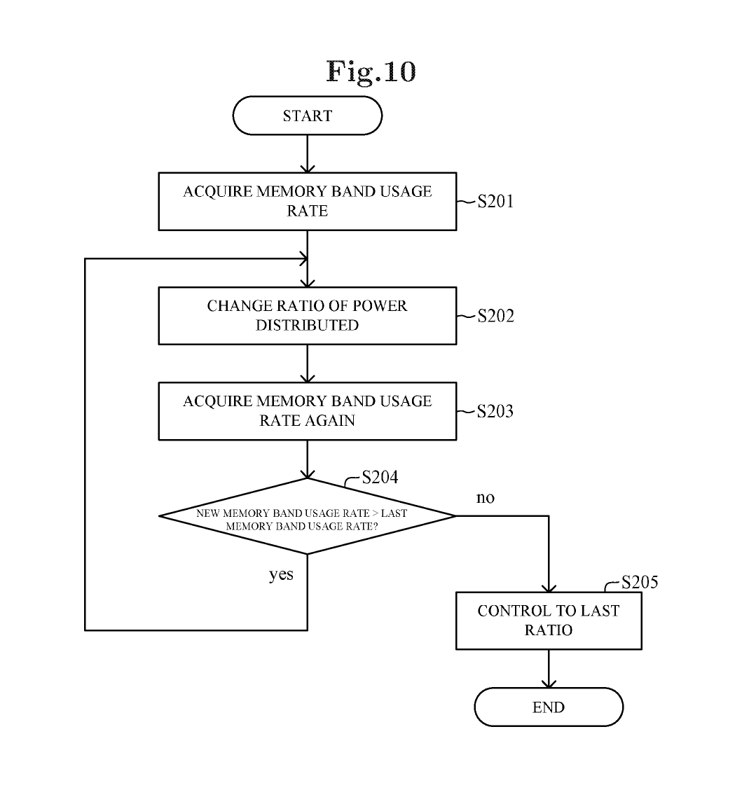

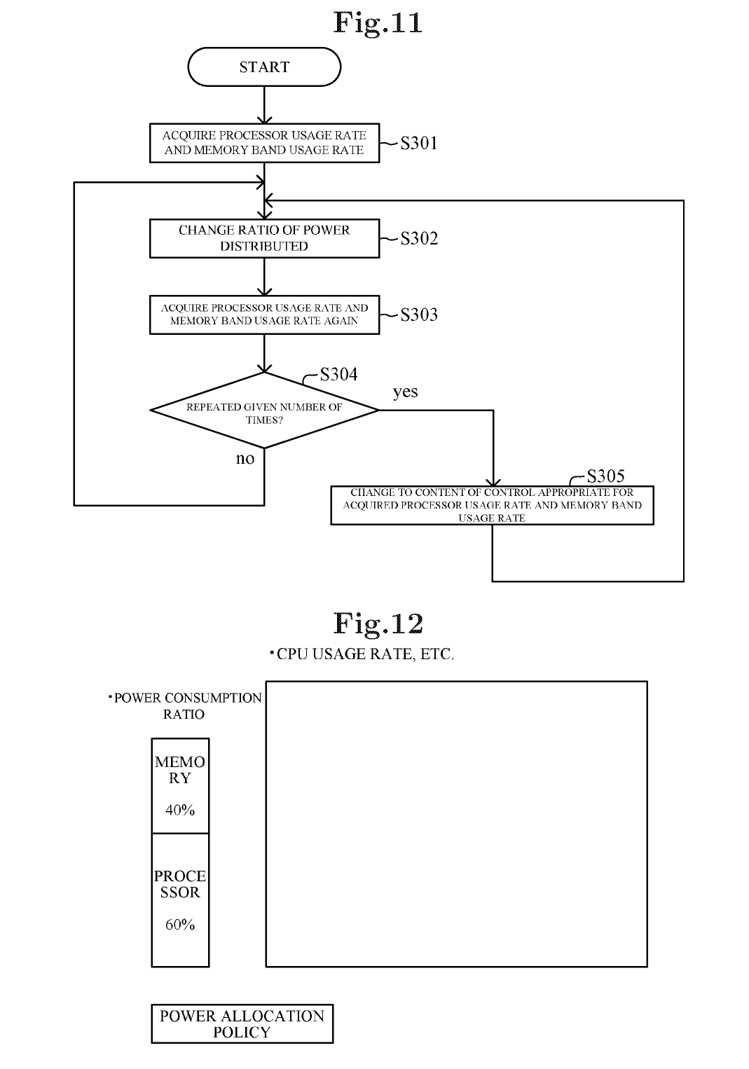

FIG. 1 is a block diagram showing an example of the configuration of a computer 1. FIG. 2 is a block diagram showing an example of the configuration of a CPU chip 2. FIG. 3 is a diagram showing an example of the configuration of a node performance controller 31. FIG. 4 is a block diagram showing an example of control by the node performance controller 31. FIG. 5 is a diagram for describing a processor-first power allocation policy set by a power allocation policy setting unit 313. FIG. 6 is a diagram for describing the hill climbing method. FIG. 7 is a diagram for describing a memory-first power allocation policy set by the power allocation policy setting unit 313. FIG. 8 is a diagram for describing a balanced power allocation policy set by the power allocation policy setting unit 313. FIG. 9 is a flowchart showing an example of the operation of the node performance controller 31 in a case where the processor-first power allocation policy is set. FIG. 10 is a flowchart showing an example of the operation of the node performance controller 31 in a case where the memory-first power allocation policy is set. FIG. 11 is a flowchart showing an example of the operation of the node performance controller 31 in a case where the balanced power allocation policy is set. FIG. 12 is a diagram showing an example of displaying a power allocation policy and the ratio of power to be allocated.

In a first exemplary embodiment of the present invention, the computer 1 (an information processing device) will be described. The computer 1 controls the ratio of power allocated to a processor die 21 and a memory die 22 included by the CPU (Central Processing Unit) chip 2 within the range of a power budget allocated to the CPU chip 2. As described later, while changing the ratio of power allocated to the processor die 21 and the memory die 22, the computer 1 in this exemplary embodiment acquires an operation status (for example, a processor usage rate and a memory band usage rate) when power is supplied at the abovementioned ratio. Then, the computer 1 controls the ratio of power newly allocated to the processor die 21 and the memory die 22 so that a preset condition is satisfied on the basis of the acquired operation status.

Referring to FIG. 1, the computer 1 in this exemplary embodiment has the CPU chip 2 and a controller chip 3 (a control device). The computer 1 in this exemplary embodiment is an information processing device which has the components described above and a storage device, and the like (the storage device, and the like, are not shown in the drawings). The computer 1 is configured to be supplied with power and execute given processing.

The CPU chip 2 is supplied with power and executes given processing such as arithmetic processing. A power budget which the CPU chip 2 is allowed to use is allocated to the CPU 2, and power is allocated to the respective components included by the CPU chip 2 within the range of the power budget.

Referring to FIG. 2, the CPU chip 2 has a processor die 21 (one of the components), a plurality of memory dies 22 including a memory die 22-1 a memory die 22-2, . . . , which will be referred to as memory dies 22 hereinafter when not distinguished particularly (one of the components), a processor die throttling register 23, a memory die throttling register 24, and a performance counter register 25, for example.

The processor die 21 has one processor or a plurality of processors. The processor die 21 is supplied with power and executes given processing such as arithmetic processing. In this exemplary embodiment, as stated above, power is allocated to the processor die 21 within the range of the power budget allocated to the CPU chip 2.

In this exemplary embodiment, a case where the CPU chip 2 has one processor die 21 will be described. However, the CPU chip 2 may have two or more processor dies 21.

The memory die 22 is a storage device such as a DRAM (Dynamic Random Access Memory). As stated above, power is allocated to the memory die 22 within the range of the power budget allocated to the CPU chip 2.

The processor die throttling register 23 is a register used in regulation of power supplied to the processor die 21. The processor die throttling register 23 is connected with the processor die 21. The node performance controller 31 to be described later regulates power supplied to the processor die 21 by using the processor die throttling register 23.

The memory die throttling register 24 is a register used in regulation of power supplied to the memory die 22. The memory die throttling register 24 is connected with the memory die 22. The node performance controller 31 to be described later regulates power supplied to the memory die 22 by using the memory die throttling register 24.

In the performance counter register 25, workload information representing the operation statuses of the processor die 21 and the memory die 22 is stored. For example, in the performance counter register 25, a processor usage rate and a memory band usage rate are stored. A processor usage rate represents the rate of a processing execution time per unit time in the processor die 21. A memory band usage rate represents the rate of a memory transfer rate to the maximum performance in the memory die 22. The node performance controller 31 to be described later refers to the performance counter register 25, and acquires the processor usage rate of the processor die 21 and the memory transfer rate of the memory die 22.

Thus, the CPU chip 2 has the processor die 21 and the memory die 22, and power is distributed to the processor die 21 and the memory die 22 included by the CPU chip 2 within the range of the power budget allocated to the CPU chip 2.

The node controller chip 3 executes control of the ratio of power distributed to the processor die 21 and the memory die 22. For example, the node controller chip 3 controls a power cap value representing the expected value of power which each of the components (the processor die 21, the memory die 22) can consume. Consequently, the node controller chip 3 executes control of power distributed to the processor die 21 and the memory die 22. In other words, for example, the node controller chip 3 controls the power cap value of the processor die 21 and the power cap value of the memory die 22 within the range of the power budget, thereby controlling the ratio of power supplied to the processor die 21 and the memory die 22.

Meanwhile, the node controller chip 3 may control the ratio of power supplied to the processor die 21 and the memory die 22 by a method other than the method illustrated above. The present invention can be implemented without depending on a method for controlling the ratio of power to be allocated.

On the node controller chip 3, the node performance controller 31 operates as a framework on the node controller chip 3. The node performance controller 31 executes overall control when controlling the ratio of power allocated to the processor die 21 and the memory die 22. Referring to FIG. 3, the node performance controller 31 has, for example, a monitor unit 311 (an operation status acquisition part), a controller unit 312 (a power allocation control part), and a power allocation policy setting unit 313 (a control condition setting part).

The monitor unit 311 monitors the operation status of at least one of the processor die 21 and the memory die 22. The monitor unit 311 in this exemplary embodiment refers to the performance counter register 25 included by the CPU chip 2, thereby acquiring workload information (the processor usage rate of the processor die 21, the memory band usage rate of the memory die 22).

Meanwhile, the monitor unit 311 may be configured to refer to the performance counter register 25 for a given time and thereby calculate the average value of the acquired processor usage rate and the average value of the acquired memory band usage rate. In this case, the monitor unit 311 and the controller unit 312 to be described later can use the average values calculated by the monitor unit 311 as the processor usage rate and the memory band usage rate.

The controller unit 312 controls the ratio of power allocated to the processor die 21 and the memory die 22 within the range of the power budget. For example, the controller unit 312 controls the ratio of allocations of the power budget to the processor die 21 and the memory die 22 by executing power capping on the processor die 21 and the memory die 22 by using the processor die throttling register 23 and the memory die throttling register 24. Moreover, the controller unit 312 in this exemplary embodiment is configured to regularly change the ratio of power allocated to the processor die 21 and the memory die 22.

Further, when controlling the ratio of allocations of the power budget, the controller unit 312 controls the ratio of power to be newly allocated, in accordance with a power allocation policy set by the power allocation policy setting unit 313 to be described later. The details of the control in accordance with the power allocation policy executed by the controller unit 312 will be described later.

The power allocation policy setting unit 313 sets a power allocation policy used when the controller unit 312 controls the ratio of power to be allocated. For example, under the user's control, the power allocation policy setting unit 313 sets one of the following three power allocation policies:

Processor-first;

Memory-transfer-amount-first; and

Balanced.

The processor-first power allocation policy is a policy of seeking a power allocation which achieves a peak processor usage rate (the highest processor usage rate). In a case where this power allocation policy is selected, the controller unit 312 controls the ratio of power allocated to the processor die 21 and the memory die 22 so that the processor usage rate becomes the highest.

The memory-transfer-amount-first power allocation policy is a policy of seeking a power allocation which achieves a peak memory band usage rate. In a case where this power allocation policy is selected, the controller unit 312 controls the ratio of power allocated to the processor die 21 and the memory die 22 so that the memory band usage rate becomes the highest.

The balanced power allocation policy is a policy of balancing the processor usage rate and the memory band usage rate. In a case where this power allocation policy is selected, the controller unit 312 seeks an allocation which achieves a peak processor usage rate and an allocation which achieves a peak memory band usage rate, and controls the ratio of power allocated to the processor die 21 and the memory die 22 to the midpoint of the peaks, for example.

With such a configuration, the node performance controller 31 controls the ratio of power allocated to the processor die 21 and the memory die 22. Referring to FIG. 4, the monitor unit 311 refers to the performance counter register 25 and acquires the processor usage rate and the memory band usage rate. Moreover, the power allocation policy setting unit 313 sets a power allocation policy under the user's control, for example. Then, on the basis of the processor usage rate and memory band usage rate acquired by the monitor unit 311 and the power allocation policy set by the power allocation policy setting unit 313, the controller unit 312 controls the ratio of power to be newly allocated, by using the processor die throttling register 23 and the memory die throttling register 24.

Now, the details of the control by the node performance controller 31 in a state that each of the power distribution policies is set will be described.

First, control executed in a case where the processor-first power allocation policy is set will be described. For example, as shown in FIG. 5, this policy is set in a case where the processor usage rate is expected to increase as the ratio of power allocated to the processor die 21 is increased. For example, this policy is set in executing a job for which the processor usage rate is particularly important.

In this case, as stated before, the controller unit 312 controls the ratio of power to be allocated so that the processor usage rate becomes the highest. That is to say, in a case where the processor-first power allocation policy is set, the controller unit 312 controls the ratio of power to be allocated so that the processor usage rate of the processor die 21, which is a previously selected component, becomes the highest.

For example, this control is executed by causing the monitor unit 311 to acquire the processor usage rate while causing the controller unit 312 to change the ratio of power allocated to the processor die 21 and the memory die 22.

To be specific, for example, the monitor unit 311 refers to the performance counter register 25 for a given time period and acquires the average value of the processor usage rate at a certain time point. Subsequently, the controller unit 312 changes the ratio of power allocated to the processor die 21 and the memory die 22 toward the processor side by one unit (for example, 1%; may be any rate). The monitor unit 311 refers to the performance counter register 25 again and acquires the average value of the processor usage rate after moving the ratio of power toward the processor side by one unit. The monitor unit 311 and the controller unit 312 continue such control until a newly acquired processor usage rate falls below a processor usage rate acquired before execution of control of the ratio of power to be allocated.

When a newly acquired processor usage rate falls below a processor usage rate acquired before control, the controller unit 312 determines that the processor usage rate acquired before the control is the peak. Then, the controller unit 312 controls a new allocated power ratio to the ratio of power when the last acquired processor usage rate has been acquired. For example, the controller unit 312 seeks the peak of the processor usage rate by using the hill climbing method (see FIG. 6). Then, the controller unit 312 controls the ratio of power allocated to the processor die 21 and the memory die 22 to the peak.

In a case where the processor-first power allocation policy is set by the power allocation policy setting unit 313, the monitor unit 311 may acquire the memory band usage rate, or need not acquire the memory band usage rate.

Next, control executed in a case where the memory-transfer-amount-first power allocation policy is set will be described. For example, as shown in FIG. 7, this policy is set in a case where the memory band usage rate is expected to increase as the ratio of power allocated to the memory die 22 is increased. For example, this policy is set in executing a job for which the memory is particularly necessary.

In this case, the controller unit 312 controls the ratio of power to be allocated so that the memory band usage rate becomes the highest as stated above. That is to say, in a case where the memory-transfer-amount-first power allocation policy is set, the controller unit 312 controls the ratio of power to be allocated so that the memory band usage rate of the memory die 22, which is a previously selected component, becomes the highest.

For example, this control is executed by causing the monitor unit 311 to acquire the memory band usage rate while causing the controller unit 312 to change the ratio of power allocated to the processor die 21 and the memory die 22.

To be specific, for example, the monitor unit 311 refers to the performance counter register 25 and acquires the average value of the memory band usage rate at a certain time point. Subsequently, the controller unit 312 changes the ratio of power allocated to the processor die 21 and the memory die 22 toward the memory side by one unit. Then, the monitor unit 311 refers to the performance counter register 25 again and acquires the average value of the memory band usage rate after moving the ratio of power to the memory side by one unit. The monitor unit 311 and the controller unit 312 continue such control until a newly acquired memory band usage rate falls below a memory band usage rate acquired before control.

When a newly acquired memory band usage rate falls below a memory band usage rate acquired before control, the controller unit 312 determines that the memory band usage rate acquired before the control is the peak. Then, the controller unit 312 controls a new allocated power ratio to the ratio of power when the memory band usage rate acquired before the control has been acquired. For example, the controller unit 312 seeks the peak of the memory band usage rate by the hill climbing method. Then, the controller unit 312 controls the ratio of power allocated to the processor die 21 and the memory die 22 to the peak.

Thus, in the same way as control executed in a case where the processor-first power allocation policy is set, control executed in a case where the memory-transfer-amount-first power allocation policy is set is executed by the hill climbing method, for example.

In a case where the memory-transfer-amount-first power allocation policy is set by the power allocation policy setting unit 313, the monitor unit 311 may acquire the processor usage rate, or need not acquire the processor usage rate.

Next, control executed in a case where the balanced power allocation policy is set will be described. For example, as shown in FIG. 8, this policy is selected in executing a job which needs to balance power to be allocated to the processor die 21 and the memory die 22. For example, this policy is executed in executing a job for which both the CPU usage rate and the memory are necessary.

In this case, the controller unit 312 seeks an allocation which achieves a peak processor usage rate and a peak memory band usage rate, and controls the ratio of power to be allocated becomes the midpoint of the peaks.

For example, this control is executed by causing the controller unit 312 to acquire the processor usage rate and the memory band usage rate while causing the controller unit 312 to change the ratio of power allocated to the processor die 21 and the memory die 22.

To be specific, for example, the monitor unit 311 refers to the performance counter register 25 and acquires the processor usage rate and the memory band usage rate at a certain time point. In this case, the ratio of power allocated to the processor die 21 and the memory die 22 at a time point of first acquisition of the processor usage rate and the memory band usage rate (for example, a time point of start of control of the ratio of power to be allocated) is used as a reference point. Subsequently, the controller unit 312 changes the ratio of power allocated to the processor die 21 and the memory die 22 toward the processor side (or may be the memory side) by one unit. Then, the monitor unit 311 refers to the performance counter register 25 again and acquires the processor usage rate and the memory band usage rate after moving the ratio of power toward the memory side by one unit.

The monitor unit 311 and the controller unit 312 repeat such control by several units (any number; for example, three times). Then, the monitor unit 311 and the controller unit 312 change the content of next control depending on the acquired processor usage rate and memory band usage rate.

For example, in a case where both the acquired processor usage rate and the acquired memory band usage rate have increased as a result of the abovementioned control, the monitor unit 311 and the controller unit 312 repeat the same control again from the ratio of power at a time point of end of the abovementioned control. In other words, acquisition of the processor usage rate and the memory band usage rate by the monitor unit 311 and control by the controller unit 312 to change the ratio of power allocated to the processor die 21 and the memory die 22 toward the processor side by one unit are continued.

Further, in a case where both the acquired processor usage rate and the acquired memory band usage rate have decreased as a result of the abovementioned control, the monitor unit 311 and the controller unit 312 execute control in the opposite direction (toward the memory side) from the ratio of power at the reference point (a time point of start of control of the ratio of power to be allocated). In other words, acquisition of the processor usage rate and the memory band usage rate by the monitor unit 311 is executed, and also, control by the controller unit 312 to change the ratio of power allocated to the processor die 21 and the memory die 22 from the reference point toward the memory side by one unit is executed.

Further, in a case where the acquired processor usage rate has increased but the acquired memory band usage rate has decreased as a result of the abovementioned control, the monitor unit 311 and the controller unit 312 execute control in the opposite direction (toward the memory side) from the ratio of power at the reference point (a time point of start of control of the ratio of power to be allocated). In other words, acquisition of the processor usage rate and the memory band usage rate by the monitor unit 311 is executed, and also control by the controller unit 312 to change the ratio of power allocated to the processor die 21 and the memory die 22 from the reference point toward the memory side by one unit is executed.

Further, in a case where the acquired processor usage rate has decreased but the acquired memory band usage rate has increased as a result of the abovementioned control, the monitor unit 311 and the controller unit 312 execute control in the same direction (toward the processor side) from the ratio of power at the reference point (a time point of start of control of the ratio of power to be allocated). In other words, acquisition of the processor usage rate and the memory band usage rate by the monitor unit 311 is executed, and control by the controller unit 312 to change the ratio of power allocated to the processor die 21 and the memory die 22 from the reference point toward the processor side is executed again.

By executing control as described above, the monitor unit 311 and the controller unit 312 seek the peaks of the processor usage rate and the memory band usage rate, and control the ratio of power allocated to the processor die 21 and the memory die 22 to the midpoint of the two peaks having been sought.

Randomness (the processor side and the memory side can be exchanged; the ratio is changed by several units at one time; and so on) may be introduced to control of the ratio of power allocated to the processor die 21 and the memory die 22 executed by the controller unit 312. Moreover, the controller unit 312 may seek the midpoint of the two peaks while changing the ratio of power allocated to the processor die 21 and the memory die 22, for example. Thus, as far as the controller unit 312 can seek the peaks of the processor usage rate and the memory band usage rate and control the ratio of power allocated to the processor die 21 and the memory die 22 to the midpoint of the peaks, it is possible to use various methods.

As stated above, the node performance controller 31 in this exemplary embodiment is configured to control the ratio of power allocated to the processor die 21 and the memory die 22 on the basis of information from hardware (a processor usage rate, a memory band usage rate).

Next, an operation in controlling the ratio of power allocated to the processor die 21 and the memory die 22 will be described referring to flowcharts shown in FIGS. 9 to 11.

First, an operation executed in a case where the processor-first power allocation policy is set will be described referring to FIG. 9.

Referring to FIG. 9, the monitor unit 311 refers to the performance counter register 25. Consequently, the monitor unit 311 acquires the processor usage rate (step S101).

Subsequently, the controller unit 312 changes the ratio of power allocated to the processor die 21 and the memory die 22 toward the processor side by one unit (step S102). For example, this control is executed by the control unit 312 using the processor die throttling register 23 and the memory die throttling register 24.

After that, the monitor unit 311 refers to the performance counter register 25 again. Consequently, the monitor unit 311 acquires a processor usage rate after moving the ratio of power allocated to the processor die 21 and the memory die 22 toward the processor side by one unit (step S103).

Then, the controller unit 312 (or the node performance controller 31) compares the new processor usage rate (the processor usage rate after moving the ratio of power allocated to the processor die 21 and the memory die 22 toward the processor side by one unit) with the pre-control processor usage rate (the processor usage rate before moving the ratio of power allocated to the processor die 21 and the memory die 22 toward the processor side by one unit) (step S104).

In a case where the new processor usage rate is larger than the pre-control processor usage rate (step S104, yes), the controller unit 312 changes the ratio of power allocated to the processor die 21 and the memory die 22 toward the processor side by one unit again (step S102). After that, a processor usage rate is acquired by the monitor unit 311 again (step S103), and the comparison is performed in the same manner.

On the other hand, in a case where the new processor usage rate is equal to or less than the pre-control processor usage rate (step S104, no), the controller unit 312 controls the ratio of power allocated to the processor die 21 and the memory die 22 to the ratio of power in acquisition of the pre-control processor usage rate (step S105).

In a case where the processor-first power allocation policy is set, the node performance controller 31 seeks a power allocation which achieves a peak processor usage rate, and controls the ratio of power to be allocated so that the processor usage rate becomes the highest, through an operation as described above.

Next, an operation executed in a case where the memory-transfer-amount-first power allocation policy is set will be described referring to FIG. 10.

Referring to FIG. 10, the monitor unit 311 refers to the performance counter register 25. Consequently, the monitor unit 311 acquires the memory band usage rate (step S201).

Subsequently, the controller unit 312 changes the ratio of power allocated to the processor die 21 and the memory die 22 toward the memory side by one unit (step S202). For example, this control is executed by the control unit 312 using the processor die throttling register 23 and the memory die throttling register 24.

After that, the monitor unit 311 refers to the performance counter register 25 again. Consequently, the monitor unit 311 acquires a memory band usage rate after moving the ratio of power allocated to the processor die 21 and the memory die 22 toward the memory side by one unit (step S203).

Then, the controller unit 312 (or the node performance controller 31) compares the new memory band usage rate (the memory band usage rate after moving the ratio of power allocated to the processor die 21 and the memory die 22 toward the memory side by one unit) with the pre-control memory band usage rate (the memory band usage rate before moving the ratio of power allocated to the processor die 21 and the memory die 22 toward the memory side by one unit) (step S204).

In a case where the new memory band usage rate is larger than the pre-control memory band usage rate (step S204, yes), the controller unit 312 changes the ratio of power allocated to the processor die 21 and the memory die 22 toward the memory side by one unit again (step S202). After that, the memory band usage rate is acquired by the monitor unit 311 again (step S203), and the comparison is performed in the same manner.

On the other hand, in a case where the new memory band usage rate is equal to or less than the pre-control memory band usage rate (step S204, no), the controller unit 312 controls the ratio of power allocated to the processor die 21 and the memory die 22 to the ratio of power in acquisition of the pre-control memory band usage rate (step S205).

In a case where the memory-transfer-amount-first power allocation policy is set, the node performance controller 31 seeks a power allocation which achieves a peak memory band usage rate, and controls the ratio of power to be allocated so that the memory band usage rate becomes the highest, through an operation as described above.

Next, an operation executed in a case where the balanced power allocation policy is set will be described referring to FIG. 11.

Referring to FIG. 11, the monitor unit 311 refers to the performance counter register 25. Consequently, the monitor unit 311 acquires the processor usage rate and the memory band usage rate (step S301).

Subsequently, the controller unit 312 changes the ratio of power allocated to the processor die 21 and the memory die 22 toward the processor side by one unit (step S302). For example, this control is executed by the control unit 312 using the processor die throttling register 23 and the memory die throttling register 24.

After that, the monitor unit 311 refers to the performance counter register 25 again. Consequently, the monitor unit 311 acquires a processor usage rate and a memory band usage rate after moving the ratio of power allocated to the processor die 21 and the memory die 22 toward the processor side by one unit (step S303).

The monitor unit 311 and the controller unit 312 repeat the operation of changing the ratio of power to be allocated and the operation of acquiring the processor usage rate and the memory band usage rate a given number of times (for example, three times) (step S304). Then, after repeating the abovementioned operations the given number of times (step S304, yes), the monitor unit 311 and the controller unit 312 change the content of next control depending on the acquired processor usage rate and memory band usage rate (step S305).

For example, in a case where both the acquired processor usage rate and the acquired memory band usage rate have increased as a result of the abovementioned control, the monitor unit 311 and the controller unit 312 repeat the same control again from the ratio of power at a time point of end of the abovementioned control. Moreover, for example, in a case where both the acquired processor usage rate and the acquired memory band usage rate have decreased as a result of the abovementioned control, the monitor unit 311 and the controller unit 312 execute control in the opposite direction (toward the memory side) from the ratio of power at the reference point (a time point of start of control of the ratio of power to be allocated). Moreover, for example, in a case where the acquired processor usage rate has increased but the acquired memory band usage rate has decreased as a result of the abovementioned control, the monitor unit 311 and the controller unit 312 executes control in the opposite direction (toward the memory side) from the ratio of power at the reference point (a time point of start of control of the ratio of power to be allocated). Moreover, for example, in a case where the acquired processor usage rate has decreased but the acquired memory band usage rate has increased as a result of the abovementioned control, the monitor unit 311 and the controller unit 312 executes control in the same direction (toward the processor side) from the ratio of power at the reference point (a time point of start of control of the ratio of power to be allocated).

Thus, the monitor unit 311 and the controller unit 312 acquire the processor usage rate and the memory band usage rate while changing the ratio of power to be allocated again in accordance with the changed control content. Then, the monitor unit 311 and the controller unit 312 change the content of control again in response to the result.

In a case where the balanced power allocation policy is set, the node performance controller 31 seeks power allocations which achieve a peak processor usage rate and a peak memory band usage rate, respectively, and controls the ratio of power to the midpoint of the sought two peaks, through an operation as described above.

Randomness (the processor side and the memory side are exchanged with each other; the ratio is changed by several units at one time; and so on) may be introduced to control of the ratio of power allocated to the processor die 21 and the memory die 22 executed by the controller unit 312.

That is an example of the operation in controlling the ratio of power allocated to the processor die 21 and the memory die 22.

As described above, the computer 1 in this exemplary embodiment has the monitor unit 311 and the controller unit 312 on the node performance controller 31. With such a configuration, the node performance controller 31 can cause the monitor unit 311 to acquire the processor usage rate and the memory band usage rate while causing the controller unit 312 to change the ratio of power allocated to the processor die 21 and the memory die 22. As a result, the node performance controller 31 can control the ratio of power to be allocated so that a power allocation policy set by the power allocation policy setting unit 313 is satisfied. Consequently, the node performance controller 31 can control the ratio of power allocated to the processor die 21 and the memory die 22 to a ratio that fits workload performance.

The computer 1 can be configured to display a power allocation policy set by the power allocation policy setting unit 313 and a power allocation ratio regulated by the node performance controller 31 when displaying the CPU usage rate as shown in FIG. 12, for example.

Further, in this exemplary embodiment, the node performance controller 31 operates as a framework on the node controller chip 3. However, a means for realizing the node performance controller 31 is not limited to the illustration in this exemplary embodiment. For example, the node performance controller 31 may be realized on an operating system operating on the computer 1.

Further, in this exemplary embodiment, the power allocation policy setting unit 313 is configured to set a power allocation policy under the user's control, for example. However, a means for setting a power allocation policy by the power allocation policy setting unit 313 is not limited to the illustration above. The power allocation policy setting unit 313 may be configured to automatically set a power allocation policy depending on the content of control executed by the CPU chip 2, for example.

Further, in this exemplary embodiment, a case where the computer 1 has one CPU chip 2 has been described. However, the computer 1 may have two or more CPU chips 2.

Further, a method of control by the node performance controller 31 in a case where the processor-first power allocation policy or the memory-first power allocation policy is set is not limited to the illustration in this exemplary embodiment. The node performance controller 31 may be configured to, for example, after executing acquisition of an operation status and control of the ratio of power to be allocated several times, change the content of next control depending on whether the acquired operation status (the processor usage rate, the memory band usage rate) has increased or decreased. For example, the node performance controller 31 may be configured to, in a case where the operation status has increased, and control the ratio of power to be allocated so as to repeat the control again from the ratio of power at a time point of end of the control. On the other hand, the node performance controller 31 may be configured to, in a case where the operation status has decreased, control the ratio of power to be allocated in the opposite direction (toward the memory side) from the ratio of power at the reference point. Further, the method of control by the node performance controller 31 is not limited to the hill climbing method. The node performance controller 31 may be configured to use various methods such as best-first search.

### Second Exemplary Embodiment

In a second exemplary embodiment of the present invention, a computer 5 controlling the ratio of power allocated to the processor die 21 and the memory die 22 included by the CPU chip 2 within the range of a power budget allocated to the CPU chip 2 will be described. The computer 5 in this exemplary embodiment is configured to acquire performance information (throughput, and the like) of a job executed on the CPU chip 2. As described later, the computer 5 in this exemplary embodiment acquires performance information in being supplied with power at the ratio of power allocated to the processor die 21 and the memory die 22 and executing a job while changing the ratio. Then, the computer 5 controls the ratio of power newly allocated to the processor die 21 and the memory die 22 so that the performance of the job executed on the CPU chip 2 becomes the best on the basis of the acquired performance information.

The computer 5 in this exemplary embodiment has almost the same configuration as the computer 1 described in the first exemplary embodiment. That is to say, the computer 5 has the CPU chip 2 and the node controller 3 (see FIG. 1). The CPU chip 2 has the processor die 21, the memory die 22, the processor die throttling register 23, the memory die throttling register 24, and the performance counter register 25 (see FIG. 2). The node performance controller 31 on the node controller 3 has the monitor unit 311, the controller unit 312, and the power allocation policy setting unit 313 (see FIG. 3).

Thus, the computer 5 in this exemplary embodiment has almost the same configuration as the computer 1 described in the first exemplary embodiment. On the other hand, the computer 5 is different from the computer 1 in acquiring performance information showing the capacity to process a job executed on the CPU chip 2 and, on the basis of the performance information, controlling the ratio of power allocated to the processor die 21 and the memory die 22. Below, the different point from the first exemplary embodiment will be described in detail.

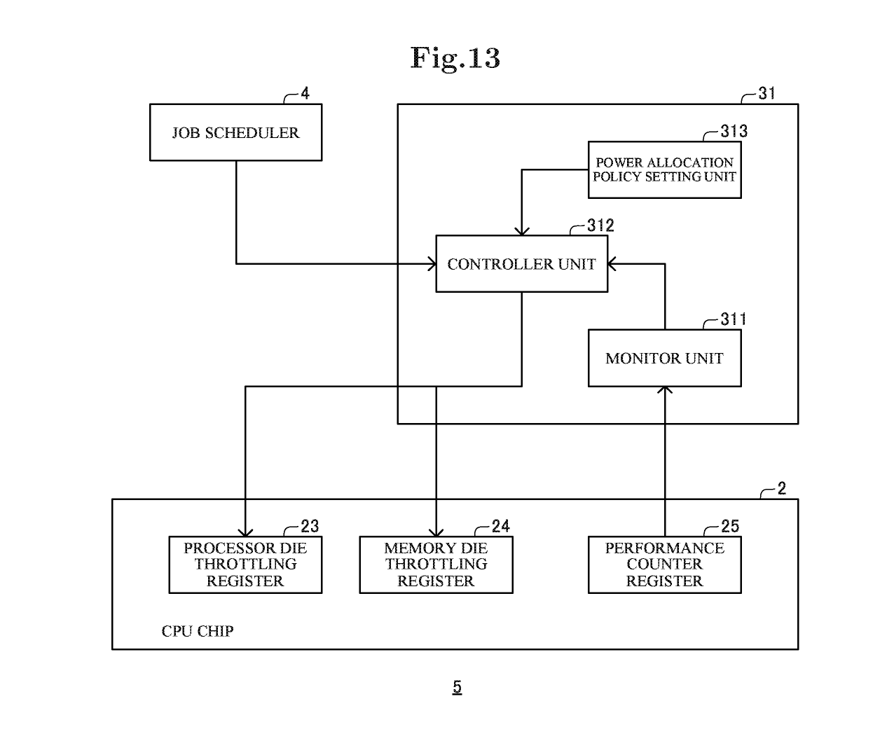

Referring to FIG. 13, the computer 5 in this exemplary embodiment has a job scheduler 4 (one of the operation status acquisition part) in addition to the abovementioned components. For example, the job scheduler 4 is realized on an operating system operating on the computer 5.

The job scheduler 4 manages a job executed on the CPU chip 2. Moreover, when a job is executed on the CPU chip 2, the job scheduler 4 regularly acquires performance information of the executed job. Performance information is information for a job executed on the CPU chip 2, such as a benchmark, GFLOPS (GigaFLOPs), and the number of recognized faces in execution of a face recognition process. Performance information represents a capacity to process a job executed on the CPU chip 2 per unit time.

The job scheduler 4 transmits acquired performance information to the node performance controller 31 in response to an instruction from the node performance controller 31 as shown in FIG. 13. Meanwhile, the job scheduler 4 may be configured to transmit the average value of all performance information in a current time interval (for example, from reception of a transmission instruction to the last five seconds) to the node performance controller 31 in response to an instruction from the node performance controller 31.

As stated above, the node performance controller 31 (or the controller unit 312) in this exemplary embodiment instructs the job scheduler 4 to transmit performance information.

Further, the controller unit 312 in this exemplary embodiment controls the ratio of power to be allocated so that processing capacity represented by performance information becomes the highest.

This control is executed by, for example, causing the job scheduler 4 to acquire performance information while causing the controller unit 312 to change the ratio of power allocated to the processor die 21 and the memory die 22.

To be specific, for example, the job scheduler 4 acquires performance information of a job executed on the CPU chip 2. In this case, the node performance controller 31 uses, as a reference point, the ratio of power allocated to the processor die 21 and the memory die 22 at a time point of first acquiring performance information (for example, a time point of start of control of the ratio of power to be allocated). Subsequently, the controller unit 312 changes the ratio of power allocated to the processor die 21 and the memory die 22 toward the processor side by one unit. After that, the job scheduler 4 acquires performance information again.

The job scheduler 4 and the controller unit 312 repeat such control by several units. Then, the job scheduler 4 and the controller unit 312 change the content of next control depending on the acquired performance information.

For example, in a case where processing capacity represented by the acquired performance information has increased as a result of the abovementioned control, the job scheduler 4 and the controller unit 312 repeat control in the same direction from the ratio of power at a time point of end of the abovementioned control. In other words, acquisition of performance information by the job scheduler 4 and control by the controller unit 312 of changing the ratio of power allocated to the processor die 21 and the memory die 22 toward the processor side by one unit are continued.

Further, in a case where processing capacity represented by the acquired performance information has decreased as a result of the abovementioned control, the job scheduler 4 and the controller unit 312 execute control in the opposite direction (toward the memory side) from the ratio of power at the reference point (a time point of start of control of the ratio of power to be allocated). In other words, acquisition of performance information is performed by the job scheduler 4, and control of changing the ratio of power allocated to the processor die 21 and the memory die 22 from the reference point toward the memory side by one unit is executed by the controller unit 312.

The job scheduler 4 and the controller unit 312 seek the peak of processing capacity represented by performance information and controls the ratio of power allocated to the processor die 21 and the memory die 22 to the peak having been sought, for example, by execution of control as described above. Meanwhile, the job scheduler 4 and the controller unit 312 may be configured to seek the peak of processing capacity represented by performance information, for example, by continuing control of the ratio of power to be allocated and acquisition of performance information until newly acquired performance information falls below pre-control performance information.

Thus, the node performance controller 31 in this exemplary embodiment is configured to control the ratio of power allocated to the processor die 21 and the memory die 22 on the basis of information (performance information) from software.

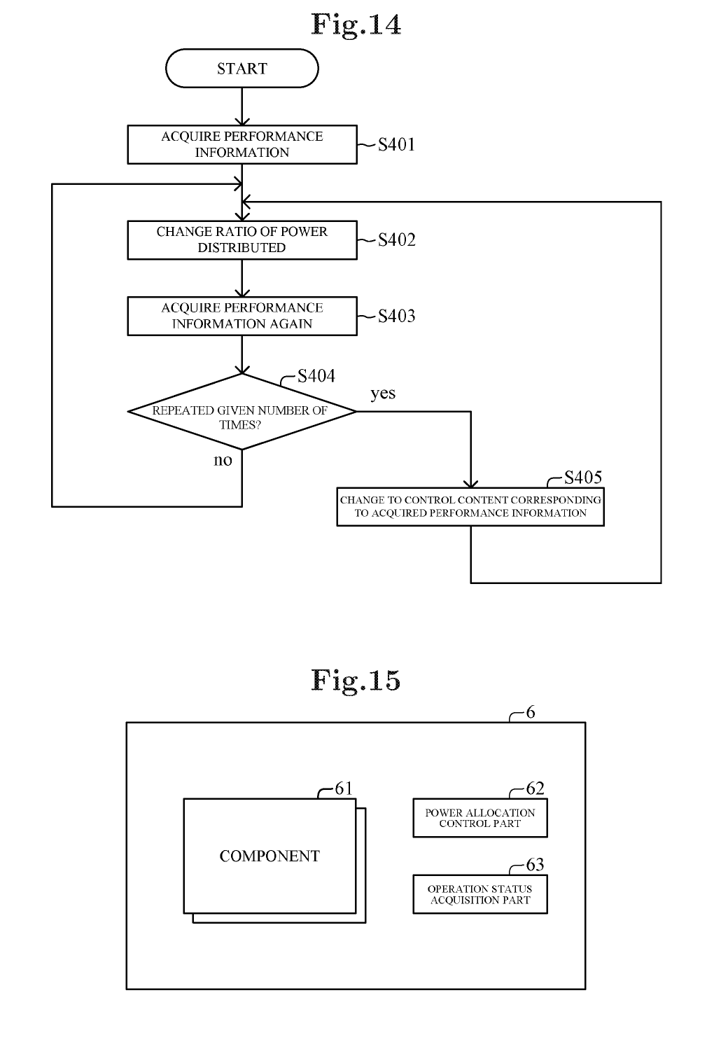

Next, an operation in controlling the ratio of power allocated to the processor die 21 and the memory die 22 in this exemplary embodiment will be described referring to a flowchart shown in FIG. 14.

Referring to FIG. 14, the job scheduler 4 acquires performance information (step S401).

Subsequently, the controller unit 312 changes the ratio of power allocated to the processor die 21 and the memory die 22 toward the processor side by one unit (step S402). This control is executed, for example, by the controller unit 312 using the processor die throttling register 23 and the memory die throttling register 24.

After that, the job scheduler 4 acquires performance information again (step S403).

The job scheduler 4 and the controller unit 312 repeat the operation of changing the ratio of power to be allocated and the operation of acquiring performance information a given number of times (for example, three times) (step S404). After repeating the abovementioned operations the given number of times (step S404, yes), the job scheduler 4 and the controller unit 312 change the content of next control depending on the acquired performance information (step S405).

For example, in a case where the acquired performance information has increased as a result of the abovementioned control, the job scheduler 4 and the controller unit 312 execute control in the same direction again from the ratio of power at a time point of end of the abovementioned control. Moreover, for example, in a case where the acquired performance information has decreased as a result of the abovementioned control, the job scheduler 4 and the controller unit 312 execute control in the opposite direction (toward the memory side) from the ratio of power at the reference point (a time point of start of control of the ratio of power to be allocated).

Thus, the job scheduler 4 and the controller unit 312 acquire performance information while again changing the ratio of power to be allocated in accordance with the content of control after changed. Then, the job scheduler 4 and the controller unit 312 change the content of control again in response to the result.

The node performance controller 31 in this exemplary embodiment seeks a power allocation achieving the peak of processing capacity represented by performance information and controls the ratio of power to be allocated, for example, through an operation as described above.

That is an example of the operation in controlling the ratio of power allocated to the processor die 21 and the memory die 22.

Thus, the computer 5 in this exemplary embodiment has the job scheduler 4. With such a configuration, the node performance controller 31 can cause the job scheduler 4 to acquire performance information while causing the controller unit 312 to change the ratio of power allocated to the processor die 21 and the memory die 22. As a result, the node performance controller 31 can control the ratio of power to be allocated so that processing capacity represented by performance information becomes the maximum. Consequently, the node performance controller 31 can control the ratio of power allocated to the processor die 21 and the memory die 22 to a ratio that fits workload performance more.

The power allocation policy setting unit 313 may be configured to be able to select either execution of control of the ratio of power to be allocated on the basis of the processor usage rate, memory band usage rate, and the like, acquired by the monitor unit 311 or execution of control of power to be allocated on the basis of performance information acquired by the job scheduler 4.

Further, the computer 5 in this exemplary embodiment has the performance counter register 25 and the monitor unit 311. However, the computer 5 need not have the performance counter register 25 or the monitor unit 311 necessarily.

### Third Exemplary Embodiment

In a third exemplary embodiment of the present invention, an information processing device 6 distributing power to each of a plurality of components will be described. In this exemplary embodiment, the overview of the configuration of the information processing device 6 will be described.

Referring to FIG. 15, the information processing device 6 in this exemplary embodiment has a plurality of components 61, a power allocation control part 62, and an operation status acquisition part 63.

The plurality of components 61 are supplied with power and perform given operations.

The power allocation control part 62 controls the ratio of power allocated to the respective components. To be specific, the power allocation control part 62 controls the ratio of power allocated to the plurality of components so that a preset condition is satisfied on the basis of the operation status of at least one of the components acquired by the operation status acquisition part 63 to be described later.

The operation status acquisition part 63 acquires the operation status of at least one of the plurality of components 61.

Thus, the information processing device 6 in this exemplary embodiment has the power allocation control part 62 and the operation status acquisition part 63. With such a configuration, the operation status acquisition part 63 can acquire the operation status of at least one of the plurality of components 61. As a result, the power allocation control part 62 can control the ratio of power allocated to the plurality of components 61 so that a preset condition is satisfied. Consequently, the power allocation control part 62 can control the ratio of power allocated to the plurality of components 61 to a ratio that fits the performance of workload executed by the plurality of components.

Further, the information processing device 6 stated above can be realized by installation of a given program into the information processing device 6. To be specific, a program as another aspect of the present invention is a program which: causes an information processing device having a plurality of components supplied with power and executing given operations to realize a power allocation control unit controlling the ratio of power allocated to the plurality of components and an operation status acquisition unit acquiring the operation status of at least one of the plurality of components; and controls the ratio of power allocated to the plurality of components so that a preset condition is satisfied on the basis of the operation status of at least one of the plurality of components.

Further, a power control method executed through operation of the information processing device 6 is a method including: acquiring the operation status of at least one of a plurality of components; and controlling the ratio of power allocated to a plurality of components so that a preset condition is satisfied on the basis of the acquired operation status of at least one of the plurality of components.

The program and the power control method having the abovementioned configurations can also achieve the abovementioned object of the present invention because they have the same actions as the information processing device 6.

### Fourth Exemplary Embodiment

In a fourth exemplary embodiment of the present invention, a control device 7 distributing power to each of a plurality of components will be described. In this exemplary embodiment, the overview of the configuration of the control device 7 will be described.

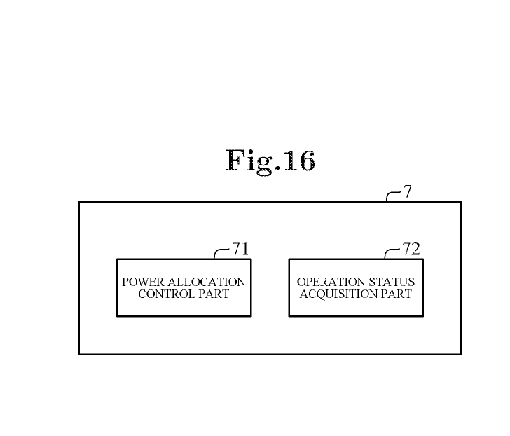

Referring to FIG. 16, the control device 7 in this exemplary embodiment has a power allocation control part 71 and an operation status acquisition part 72.

The power allocation control part 71 controls the ratio of power allocated to a plurality of components. To be specific, the power allocation control part 71 controls the ratio of power allocated to the components so that a preset condition is satisfied on the basis of the operation status of at least one of the components acquired by the operation status acquisition part 72 to be described later.

The operation status acquisition part 72 acquires the operation status of at least one of a plurality of components.

Thus, the control device 7 in this exemplary embodiment has the power allocation control part 71 and the operation status acquisition part 72. With such a configuration, the operation status acquisition part 72 can acquire the operation status of at least one of a plurality of components. As a result, the power allocation control part 71 can control the ratio of power allocated to the components so that a preset condition is satisfied on the basis of the operation status acquired by the operation status acquisition part 72. Consequently, the power allocation control part 71 can control the ratio of power allocated to a plurality of components to a ratio that fits the performance of workload executed by a plurality of components.

### <Supplementary Notes>

The whole or part of the exemplary embodiments disclosed above can be described as the following supplementary notes. Below, the overview of an information processing device, and so on, according to the present invention will be described. However, the present invention is not limited to the following configurations.

### (Supplementary Note 1)

An information processing device having a plurality of components which are supplied with power and perform given operations, the information processing device comprising microprocessor including:

a plurality of components supplied with power and performing given operations;

a power allocation control part controlling a ratio of power allocated to the plurality of components; and

an operation status acquisition part acquiring an operation status of at least one of the plurality of components,

wherein the power allocation control part controls a ratio of power allocated to the plurality of components so that a preset condition is satisfied on a basis of an operation status of at least one of the plurality of components.

### (Supplementary Note 2)

The information processing device according to Supplementary Note 1, wherein:

the power allocation control part changes a ratio of power allocated to the plurality of components for finding a power ratio satisfying a preset condition and controls the ratio of power allocated to the plurality of components to the ratio having been found.

### (Supplementary Note 3)

The information processing device according to Supplementary Note 1 or 2, wherein:

the operation status acquisition part is configured to acquire workload information as an operation status of at least one of the plurality of components, the workload information representing how a component operates with respect to maximum performance; and

the power allocation control part controls a ratio of power allocated to the plurality of components so that a preset condition is satisfied on a basis of the acquired workload information.

### (Supplementary Note 4)

The information processing device according to Supplementary Note 3, wherein:

the operation status acquisition part acquires the workload information while the power allocation control part changes a ratio of power allocated to the plurality of components for finding a power ratio achieving a highest operation ratio with respect to maximum performance of a previously selected component, and the power allocation control part controls the ratio of power allocated to the plurality of components to the ratio having been found.

### (Supplementary Note 5)

The information processing device according to Supplementary Note 3, wherein:

the operation status acquisition part acquires the workload information of at least a first component and a second component while the power allocation control part changes a ratio of power allocated to at least the first component and the second component for finding a power ratio achieving a highest operation ratio with respect to maximum performance of the first component and a power ratio achieving a highest operation ratio with respect to maximum performance of the second component, and the power allocation control part controls the ratio of power allocated to the plurality of components to a midpoint of the two power ratios having been found.

### (Supplementary Note 6)

The information processing device according to any of Supplementary Notes 1 to 3, configured to execute given processing by using the plurality of components, wherein:

the operation status acquisition part is configured to acquire performance information as an operation status of at least one of the plurality of components, the performance information representing processing capacity in executing the given processing by using the plurality of components; and

the power allocation control part controls a ratio of power allocated to the plurality of components so that a preset condition is satisfied on a basis of the acquired performance information.

### (Supplementary Note 7)

The information processing device according to Supplementary Note 6, wherein:

the operation status acquisition part acquires the performance information while the power allocation control part changes a ratio of power allocated to the plurality of components for finding a power ratio achieving highest processing capacity represented by the performance information, and the power allocation control part controls the ratio of power allocated to the plurality of components to the ratio having been found.

### (Supplementary Note 8)

The information processing device according to any of Supplementary Notes 1 to 7, comprising:

a control condition setting part setting a condition for control of a ratio of power allocated to the plurality of components by the power allocation control part.

### (Supplementary Note 9)

A power control method comprising:

acquiring an operation status of at least one of a plurality of components; and

controlling a ratio of power allocated to the plurality of components so that a preset condition is satisfied on a basis of the acquired operation status of at least one of the plurality of components.

### (Supplementary Note 10)

The power control method according to Supplementary Note 9, comprising:

acquiring an operation status of at least one of the plurality of components while changing a ratio of power allocated to the plurality of components for finding a power ratio satisfying a preset condition, and controlling the ratio of power allocated to the plurality of components to the ratio having been found.

### (Supplementary Note 11)

A non-transitory computer-readable medium storing a program comprising instructions for causing an information processing device which has a plurality of components supplied with power and performing given operations to realize:

a power allocation control unit controlling a ratio of power allocated to the plurality of components; and

an operation status acquisition unit acquiring an operation status of at least one of the plurality of components,

wherein the power allocation control part controls a ratio of power allocated to the plurality of components so that a preset condition is satisfied on a basis of an operation status of at least one of the plurality of components.

### (Supplementary Note 12)

The non-transitory computer-readable medium storing the program according to Supplementary Note 11, wherein:

the operation status acquisition unit acquires an operation status of at least one of the plurality of components while the power allocation control unit changes a ratio of power allocated to the plurality of components for finding a power ratio satisfying a preset condition, and the power allocation control unit controls the ratio of power allocated to the plurality of components to the ratio having been found.

### (Supplementary Note 13)

A control device comprising a microprocessor including:

a power allocation control part controlling a ratio of power allocated to a plurality of components supplied with power and performing given operations; and

an operation status acquisition part acquiring an operation status of at least one of the plurality of components,

wherein the power allocation control part controls a ratio of power allocated to the plurality of components so that a preset condition is satisfied on a basis of an operation status of at least one of the plurality of components.

The program disclosed in the exemplary embodiments and supplementary notes is stored in a storage device or recorded on a computer-readable recording medium. For example, the recording medium is a portable medium such as a flexible disk, an optical disk, a magneto-optical disk, and a semiconductor memory.

Although the present invention has been described above referring to the exemplary embodiments, the present invention is not limited to the exemplary embodiments described above. The configurations and details of the present invention can be changed and modified in a various manners within the scope of the present invention.

1. An information processing device having a plurality of components which are supplied with power and perform given operations, the information processing device comprising a microprocessor including:
a power allocation control part controlling a ratio of power allocated to the plurality of components; and
an operation status acquisition part acquiring an operation status of at least one of the plurality of components,
wherein the power allocation control part controls a ratio of power allocated to the plurality of components so that a preset condition is satisfied on a basis of an operation status of at least one of the plurality of components.

2. The information processing device according to claim 1, wherein:
the power allocation control part changes a ratio of power allocated to the plurality of components for finding a power ratio satisfying a preset condition and controls the ratio of power allocated to the plurality of components to the ratio having been found.

3. The information processing device according to claim 1, wherein:
the operation status acquisition part is configured to acquire workload information as an operation status of at least one of the plurality of components, the workload information representing how a component operates with respect to maximum performance; and
the power allocation control part controls a ratio of power allocated to the plurality of components so that a preset condition is satisfied on a basis of the acquired workload information.

4. The information processing device according to claim 3, wherein:
the operation status acquisition part acquires the workload information while the power allocation control part changes a ratio of power allocated to the plurality of components for finding a power ratio achieving a highest operation ratio with respect to maximum performance of a previously selected component, and the power allocation control part controls the ratio of power allocated to the plurality of components to the ratio having been found.

5. The information processing device according to claim 3, wherein:
the operation status acquisition part acquires the workload information of at least a first component and a second component while the power allocation control part changes a ratio of power allocated to at least the first component and the second component for finding a power ratio achieving a highest operation ratio with respect to maximum performance of the first component and a power ratio achieving a highest operation ratio with respect to maximum performance of the second component, and the power allocation control part controls the ratio of power allocated to the plurality of components to a midpoint of the two power ratios having been found.

6. The information processing device according to claim 1, configured to execute given processing by using the plurality of components, wherein:
the operation status acquisition part is configured to acquire performance information as an operation status of at least one of the plurality of components, the performance information representing processing capacity in executing the given processing by using the plurality of components; and
the power allocation control part controls a ratio of power allocated to the plurality of components so that a preset condition is satisfied on a basis of the acquired performance information.

7. The information processing device according to claim 6, wherein:
the operation status acquisition part acquires the performance information while the power allocation control part changes a ratio of power allocated to the plurality of components for finding a power ratio achieving highest processing capacity represented by the performance information, and the power allocation control part controls the ratio of power allocated to the plurality of components to the ratio having been found.

8. The information processing device according to claim 1, comprising:
a control condition setting part setting a condition for control of a ratio of power allocated to the plurality of components by the power allocation control part.

9. A power control method comprising:
acquiring an operation status of at least one of a plurality of components; and
controlling a ratio of power allocated to the plurality of components so that a preset condition is satisfied on a basis of the acquired operation status of at least one of the plurality of components.

10. The power control method according to claim 9, comprising:
acquiring an operation status of at least one of the plurality of components while changing a ratio of power allocated to the plurality of components for finding a power ratio satisfying a preset condition, and controlling the ratio of power allocated to the plurality of components to the ratio having been found.

11. A non-transitory computer-readable medium storing a program comprising instructions for causing an information processing device which has a plurality of components supplied with power and performing given operations to realize:
a power allocation control unit controlling a ratio of power allocated to the plurality of components; and
an operation status acquisition unit acquiring an operation status of at least one of the plurality of components,
wherein the power allocation control part controls a ratio of power allocated to the plurality of components so that a preset condition is satisfied on a basis of an operation status of at least one of the plurality of components.

12. The non-transitory computer-readable medium storing the program according to claim 11, wherein:
the operation status acquisition unit acquires an operation status of at least one of the plurality of components while the power allocation control unit changes a ratio of power allocated to the plurality of components for finding a power ratio satisfying a preset condition, and the power allocation control unit controls the ratio of power allocated to the plurality of components to the ratio having been found.

13. A control device comprising a microprocessor including:
a power allocation control part controlling a ratio of power allocated to a plurality of components supplied with power and performing given operations; and
an operation status acquisition part acquiring an operation status of at least one of the plurality of components,
wherein the power allocation control part controls a ratio of power allocated to the plurality of components so that a preset condition is satisfied on a basis of an operation status of at least one of the plurality of components.
